(19) United States
(12) Patent Application Publication
(10) Pub. No.: US 2026/0292872 A1
(43) Pub. Date: Sep. 24, 2026

(54) CHANNEL ACCESS PRIORITY FOR SIDELINK

(71) Applicant: Lenovo (Singapore) Pte. Limited, Singapore (SG)

(72) Inventors: Joachim Löhr, Wiesbaden (DE); Alexander Golitschek Edler von Elbwart, Darmstadt (DE); Karthikeyan Ganesan, Kronberg Im Taunus (DE); Prateek Basu Mallick, Dreieich (DE)

(73) Assignee: Lenovo (Singapore) Pte. Limited, Singapore (SG)

(21) Appl. No.: 18/998,069

(22) PCT Filed: Jul. 20, 2023
(86) PCT No.: PCT/IB2023/057426

§ 371 Date: Jan. 23, 2025

Related U.S. Application Data
(60) Provisional application No. 63/391,921, filed on Jul. 25, 2022.

(51) Int. Cl. H04W 74/0808; H04W 72/25

(52) U.S. Cl. CPC H04W 74/0808; H04W 72/25

(57) ABSTRACT

Various aspects of the present disclosure relate to methods, apparatuses, and systems that support channel access priority for sidelink. For instance, implementations provide efficient channel access priority class (CAPC) handling for sidelink transmission that considers delay attributes (e.g., packet delay budget (PDB) parameters) of logical channels multiplexed in a transport block on a cell configured with shared spectrum. In implementations a UE selects a highest priority CAPC of one or more sidelink logical channels with a media access control (MAC) service data unit (SDU) multiplexed in a transport block.

### RELATED APPLICATION

This application claims priority to U.S. Patent Application Ser. No. 63/391,921 filed 25 Jul. 2022 entitled “CHANNEL ACCESS PRIORITY FOR SIDELINK,” the disclosure of which is incorporated by reference herein in its entirety.

### TECHNICAL FIELD

The present disclosure relates to wireless communications, and more specifically to sidelink communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for enabling sidelink transmissions between devices, such as for direct transmissions between different UEs. Sidelink transmissions may occur in unlicensed spectrum which may be shared among multiple devices, and thus listen before talk procedures can be performed to identify available channels for sidelink transmissions.

### SUMMARY

The present disclosure relates to methods, apparatuses, and systems that support channel access priority for sidelink. For instance, implementations provide efficient channel access priority class (CAPC) handling for sidelink transmission that considers delay attributes (e.g., packet delay budget (PDB) parameters) of logical channels multiplexed in a transport block on a cell configured with shared spectrum. In implementations a UE selects a highest priority CAPC of one or more sidelink logical channels (e.g., sidelink traffic channels (STCH)) with a media access control (MAC) service data unit (SDU) multiplexed in the transport block such as to enable a PDB of the transport block to be satisfied.

By utilizing the described techniques, transmission latency of high priority data can be reduced and transmission reliability of such data can be increased.

Some implementations of the methods and apparatuses described herein may further include generating a transport block including one or more MAC SDU of one or more sidelink logical channels for a sidelink transmission; performing a listen before talk procedure based at least in part on one or more listen before talk parameters for a CAPC priority, wherein the CAPC priority corresponds to a highest priority CAPC of the one or more sidelink logical channels with the one or more MAC SDU in the transport block; and transmitting the transport block based at least in part on a success of the listen before talk procedure.

Some implementations of the methods and apparatuses described herein may further include: determining the CAPC priority based at least in part on a delay parameter for the one or more sidelink logical channels; where the delay parameter includes a PDB for the transport block; further including selecting a sidelink grant for use in transmitting the transport block, and where transmitting the transport block includes transmitting the transport block using the sidelink grant; further including performing a sensing procedure to select the sidelink grant; where the method is performed by a user equipment (UE), and where the method further includes autonomously selecting the CAPC priority by the UE; where the method is performed by a user equipment (UE), and where the method further includes determining the CAPC priority based at least in part on information received from a network entity.

Some implementations of the methods and apparatuses described herein may further include: generating the transport block to include one or more MAC control elements (CE); and selecting the CAPC priority as the highest priority CAPC for the one or more MAC CE; further including: generating the transport block to include one or more sidelink broadcast control channel (SBCCH) SDU; and selecting the CAPC priority as the highest priority CAPC for the one or more SBCCH SDU; further including: generating the transport block to include one or more sidelink control channel (SCCH) SDU; and selecting the CAPC priority as the highest priority CAPC for the one or more SCCH SDU; further including selecting the CAPC priority based at least in part on priority information received as part of sidelink control information (SCI).

Some implementations of the methods and apparatuses described herein may further include performing a channel access procedure to acquire a channel occupancy time (COT) associated with a first CAPC priority for a listen before talk procedure; receiving downlink control information (DCI) specifying a sidelink grant and a second CAPC priority for the sidelink grant for a listen before talk procedure; and determining whether to utilize the COT to transmit a sidelink transmission based on a comparison of the first CAPC priority and the second CAPC priority.

Some implementations of the methods and apparatuses described herein may further include: determining that the first CAPC priority is equal to or higher than the second CAPC priority; and transmitting the sidelink transmission utilizing the COT based at least in part on the first CAPC priority being equal to or higher than the second CAPC priority; further including: determining that the first CAPC priority is lower than the second CAPC priority; terminating the COT; and initiating transmission of the sidelink transmission utilizing the sidelink grant and based at least in part on the second CAPC priority.

Some implementations of the methods and apparatuses described herein may further include: generating a transport block including one or more MAC service data units (SDU) of one or more sidelink logical channels for a sidelink transmission; and processing the transport block based on a comparison of a CAPC priority of the transport block for a listen before talk procedure to a PDB of the transport block.

Some implementations of the methods and apparatuses described herein may further include: where processing the transport block includes: determining that a contention window used for the listen before talk procedure is greater than the PDB of the transport block, where the contention window is determined based on the CAPC priority; and determining not to transmit the transport block based at least in part on the contention window for the listen before talk procedure being greater than the PDB of the transport block; where determining that the contention window based on the CAPC priority for the listen before talk procedure is greater than the PDB of the transport block occurs at one or more of: initialization of a channel access procedure for accessing the one or more sidelink logical channels; or after initialization of the channel access procedure; discarding the transport block from a transmission buffer.

Some implementations of the methods and apparatuses described herein may further include: where processing the transport block includes: determining that a contention window for the listen before talk procedure is greater than the PDB of the transport block, where the contention window is determined based on the CAPC priority; adjusting the CAPC priority; determining that a contention window based on the adjusted CAPC priority is less than the PDB of the transport block; and transmitting the transport block based at least in part on the adjusted CAPC priority; where processing the transport block includes: determining that a contention window for the listen before talk procedure is greater than the PDB of the transport block, where the contention window is determined based on the CAPC priority; adjusting the CAPC priority; determining that a contention window determined based on the adjusted CAPC priority is greater than the PDB of the transport block; and determining not to transmit the transport block based at least in part on the adjusted CAPC priority.

### BRIEF DESCRIPTION OF THE DRAWINGS

FIG. 1 illustrates an example of a wireless communications system that supports channel access priority for sidelink in accordance with aspects of the present disclosure.

FIG. 2 illustrates a scenario 200 depicting example attributes of channel access utilized in some wireless communications systems.

FIG. 3 illustrates an example MAC PDU.

FIG. 4 illustrates an example of a block diagram of a device that supports channel access priority for sidelink in accordance with aspects of the present disclosure.

FIGS. 5 through 15 illustrate flowcharts of methods that support channel access priority for sidelink in accordance with aspects of the present disclosure.

### DETAILED DESCRIPTION

In some wireless communications systems, a CAPC value is selected by a UE autonomously for configured grant (CG) physical uplink shared channel (PUSCH) transmissions. For instance, a UE selects a lowest priority CAPC of the LCHs with MAC SDU multiplexed in a transport block (TB) in scenarios where the TB doesn't contain a MAC CE or signal radio bearer (SRB). Applying the same behaviour for sidelink transmissions where a transmitting UE selects a CAPC value may cause the UE to select a CAPC that is inconsistent with data included in a transport block. For instance, a UE may select a high CAPC index (e.g., low priority CAPC) when low priority data is contained in a TB even though sidelink resources are selected according to the PDB of the TB which is determined based on the logical channel with the most stringent PDB requirement. Thus, there may be a mismatch between the CAPC value selected for a TB and the PDB of the TB. For example, in some wireless communications systems, a listen before talk procedure including a contention window determined as a function of the CAPC may not reach a condition allowing a transmission before a PDB of a TB expires, e.g., a minimum specified channel access sensing duration may be too large to accommodate the PDB.

Accordingly, the present disclosure relates to methods, apparatuses, and systems that support channel access priority for sidelink. For instance, implementations provide efficient CAPC handling for sidelink transmission that considers delay attributes (e.g., PDB parameters) of logical channels multiplexed in a transport block on a cell configured with shared spectrum. In implementations a UE selects a highest priority CAPC of one or more sidelink logical channels (e.g., STCH) with a MAC SDU multiplexed in the transport block such as to enable a PDB of the transport block to be satisfied.

In at least some implementations, a UE autonomously determines the CAPC to be used when performing CAT4 listen before talk (e.g., Type 1 listen before talk) for the transmission of a sidelink TB utilizing predefined rules. When performing listen before talk for the transmission of a sidelink TB, for instance, the UE selects the CAPC as the highest priority CAPC of the sidelink logical channel(s) with MAC SDU multiplexed in the TB, such as for scenarios where the TB doesn't contain sidelink SRB or MAC CE.

Further to at least some implementations a UE can skip a sidelink TB transmission for scenarios where a CAPC value associated with the TB cannot meet the PDB of the TB. For example, a listen before talk procedure including a contention window determined as a function of the CAPC may not allow a transmission of a transport block before a PDB for the transport block expires. In at least some implementations a UE can discard a TB from a transmission buffer in scenarios where transmission of the TB is skipped due to not meeting the PDB requirement.

Thus, by utilizing the described techniques, transmission latency of high priority data can be reduced and transmission reliability of such data can be increased.

Aspects of the present disclosure are described in the context of a wireless communications system. Aspects of the present disclosure are further illustrated and described with reference to device diagrams and flowcharts.

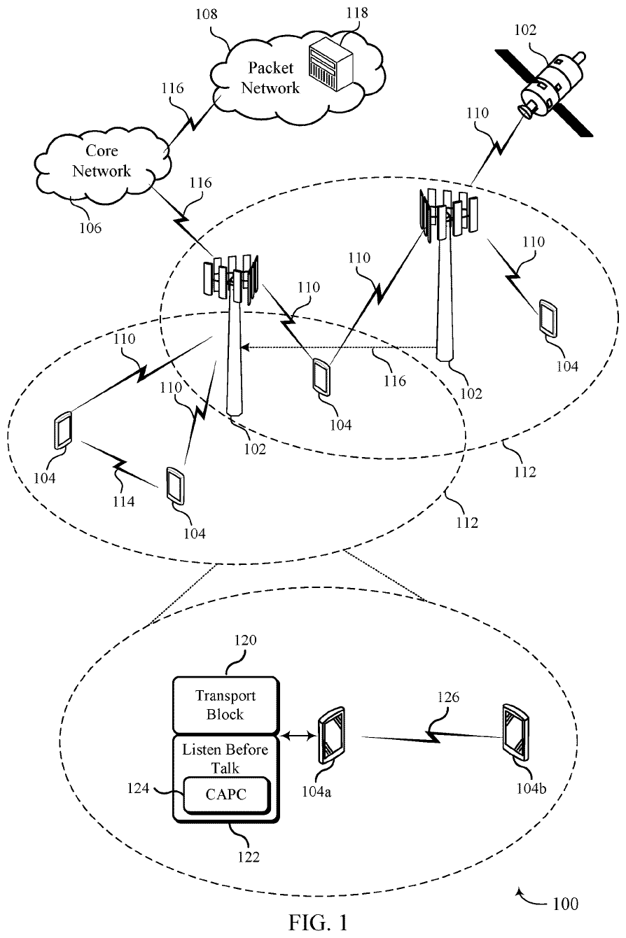

FIG. 1 illustrates an example of a wireless communications system 100 that supports channel access priority for sidelink in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol date unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for channel access priority for sidelink, a UE 104a generates a transport block 120 for transmission via sidelink. The transport block 120, for instance, includes one or more MAC SDU of one or more sidelink logical channels for a sidelink transmission. The UE 104a then performs a listen before talk procedure 122 to determine whether one or more sidelink logical channels are available for sidelink transmission of the transport block 120. In conjunction with the listen before talk procedure 122 to UE 104a selects a CAPC 124 for use in performing the listen before talk procedure 122. The UE 104a, for instance, performs the listen before talk procedure 122 based at least in part on one or more channel access parameters for the CAPC 124 priority, where the CAPC 124 priority corresponds to a highest priority CAPC of the one or more sidelink logical channels with the one or more MAC SDU in the transport block. Accordingly, after successfully performing the listen before talk procedure 122, the UE 104a transmits the transport block 120 as a sidelink transmission 126 to a UE 104b.

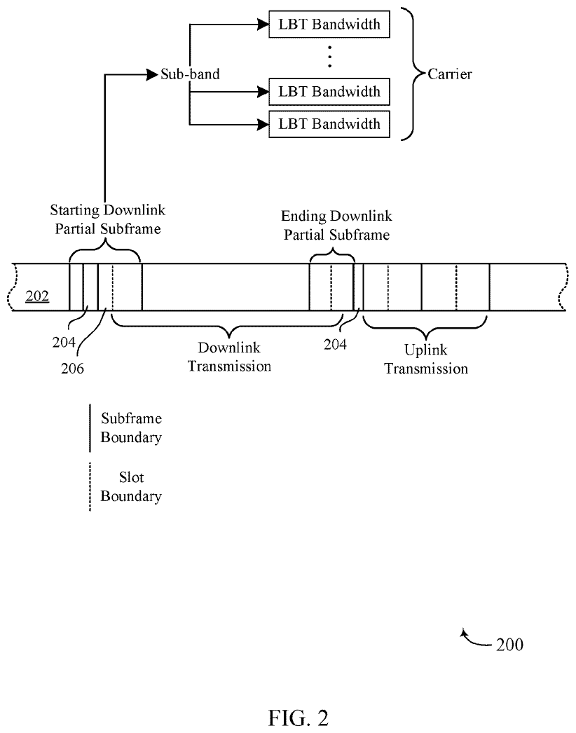

FIG. 2 illustrates a scenario 200 depicting example attributes of channel access utilized in some wireless communications systems. The scenario 200 includes a wireless channel 202 with a starting downlink partial subframe, ending downlink partial subframe, and different downlink and uplink transmission portions. Further, the wireless channel 202 includes different listen before talk portions 204 and a reservation signal portion 206. Channel access in both downlink and uplink may rely on the LISTEN BEFORE TALK. In at least some scenarios, a gNB and/or UE first senses a channel using a listen before talk procedure (e.g., a clear channel assessment (CCA)) to determine whether on-going communications exist on the channel prior to transmission. When the wireless channel 202 is a wide bandwidth unlicensed carrier, for instance, the listen before talk procedure may rely on detecting an energy level on multiple sub-bands of the wireless channel 202.

In scenarios where consistent LISTEN BEFORE TALK failure occurs, a UE is in some scenarios allowed to autonomously switch an uplink (UL) bandwidth part (BWP). This is intended such that other UL BWP(s) of a NR-U cell may mitigate a large number of LISTEN BEFORE TALK failures, e.g., different LISTEN BEFORE TALK sub-bands are used for different UL BWP(s).

For LTE eLAA, autonomous uplink (AUL) transmissions can be enabled through a combination of RRC signaling and an activation message conveyed by a DCI in a physical control channel. The RRC configuration includes subframes in which a UE is allowed to transmit autonomously, as well as eligible hybrid automatic repeat request (HARQ) process IDs. The activation message includes the resource block assignment (RBA) and modulation and coding scheme (MCS), from which the UE is able to determine the transport block size for any AUL transmission.

Some scenarios allow for autonomous retransmission of data pertaining to a transport block that has not been received correctly by a base station, e.g., eNB, gNB, etc. For this purpose, a UE can monitor downlink feedback information (AUL-DFI), which can be transmitted by a base station and includes HARQ-acknowledge (ACK) information for the AUL-enabled HARQ process IDs. When the UE detects a negative acknowledgement (NACK) message, it may try to autonomously access the channel for a retransmission of the same transport block in the corresponding HARQ process. To mitigate errors, an autonomous uplink transmission can include at least the HARQ process identifier (ID) and a new data indicator (NDI) accompanying the PUSCH, e.g., AUL-uplink control information (UCI).

Some scenarios also allow for a base station to transmit an uplink grant through a DCI that assigns uplink resources for a retransmission of the same transport block using the indicated HARQ process. The base station can also transmit an uplink grant through a DCI that assigns uplink resources for a transmission of a new transport block using the indicated HARQ process. For instance, even though a HARQ process ID can be eligible for AUL transmissions, the base station still has access to this process at any time through a scheduling grant, e.g., DCI. In general, if a UE detects a grant for an UL transmission for a subframe that is eligible for AUL (e.g., according to the RRC configuration), the UE can follow the received grant and may not perform an AUL transmission in that subframe.

TABLE 1
Fields for AUL-UCI

Bit width

| | 1 transport | 2 transport |
|---|---|---|
| Field | block | blocks |
| AUL C-radio network temporary | 16 | 16 |
| identifier (RNTI) | | |
| HARQ process number | 4 | 4 |
| Redundancy version | 2 | 2 |
| New data indicator | 1 | 2 |
| PUSCH starting symbol | 1 | 1 |
| PUSCH ending symbol | 1 | 1 |
| COT sharing indication | 1 | 1 |

Listen before talk procedures utilized by some wireless communications systems for channel access include the following:
Both base station-initiated and UE-initiated COTs use category 4 LISTEN BEFORE TALK where the start of a new transmission burst includes performing LISTEN BEFORE TALK with exponential backoff. Further, in some scenarios, a dedicated reference signal (DRS) is at most one ms in duration and is not multiplexed with unicast physical downlink shared channel (PDSCH).
UL transmission within a base station-initiated COT and/or a subsequent downlink transmission within a UE or base station-initiated COT can transmit immediately without sensing only if the gap from the end of the previous transmission is not more than 16 μs, otherwise category 2 LISTEN BEFORE TALK is to be used and the gap is not to exceed 25 μs.

In some scenarios, when a UE and/or base station in unlicensed carriers is to perform a listen before talk operation as specified by regulation and within Category 4 listen before talk, several CAPCs can be defined to have differentiated channel access parameters, such as described below in Tables 2 and 3 from technical specification (TS) 37.213.

TABLE 2
CAPC for Downlink

| Channel | | | | | |
|---|---|---|---|---|---|
| Access | | | | | |
| Priority | | | | | allowed |
| Class (p) | mₚ | CW_{min, p} | CW_{max, p} | T_{m cot, p} | CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

TABLE 3
CAPC for Uplink

| Channel | | | | | |
|---|---|---|---|---|---|
| Access | | | | | |
| Priority | | | | | allowed |
| Class (p) | mₚ | CW_{min, p} | CW_{max, p} | T_{ulm cot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

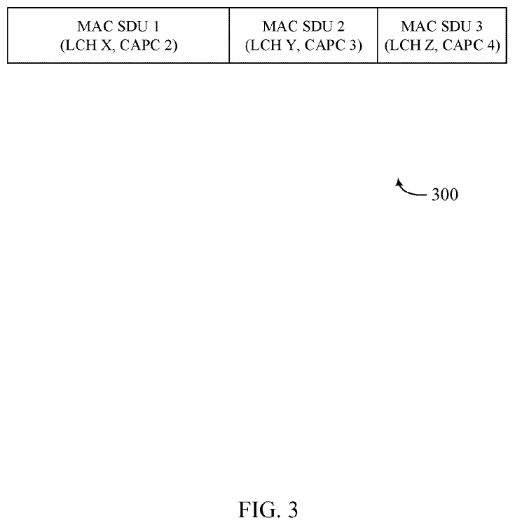

FIG. 3 illustrates an example MAC PDU 300. For instance, for dynamically scheduled uplink resources (e.g., UL DCI) a base station can indicate a CAPC to be used by a UE for the corresponding uplink transmission. For uplink configured grant, a network may not signal the CAPC index for every occasion, and thus the UE itself may select which CAPC is used for each occasion. According to some scenarios, a UE selects a lowest priority CAPC of LCHs multiplexed in a TB. For instance, for the MAC PDU 300, a UE may select the CAPC 4, e.g., the lowest priority.

With the behaviour discussed above it is possible that a small amount of data belongs to a highest CAPC index, like above, but a UE still applies a low priority CAPC index for the high-priority data, which may cause some delay for the transmission. Therefore, in some scenarios for UL CG, if SRB (e.g., dedicated control channel (DCCH)) SDU is included in MAC PDU, a UE can select the CAPC index of the SRB (DCCH). Otherwise, the UE selects the lowest priority CAPC index of LCHs multiplexed in MAC PDU. Example rules for CAPC setting are further outlined below.

The CAPC of radio bearers and MAC CEs can be either fixed or configurable:
Fixed to the lowest priority for the padding buffer status report (BSR) and recommended bit rate MAC CEs;
Fixed to the highest priority for SRB0, SRB1, SRB3 and other MAC CEs;
Configured by the gNB for SRB2 and data radio bearer (DRB).

When choosing the CAPC of a DRB, a base station can take into account the 5QIs of all the QoS flows multiplexed in that DRB while considering fairness between different traffic types and transmissions. Table 4 below shows which CAPC may be used for which standardized 5Qis, e.g., which CAPC to use for a given QoS flow. In some scenarios, a QoS flow corresponding to a non-standardized 5QI (e.g., operator specific 5QI) is to use the CAPC of the standardized 5QI which best matches the QoS characteristics of the non-standardized 5QI.

| CAPC | 5QI |
|---|---|
| 1 | 1, 3, 5, 65, 66, 67, 69, 70, |
| | 79, 80, 82, 83, 84, 85 |
| 2 | 2, 7, 71 |
| 3 | 4, 6, 8, 9, 72, 73, 74, 76 |
| 4 | . . . |

NOTE1:
lower CAPC value corresponds to higher priority

In some scenarios when performing CAT4 listen before talk (e.g., Type 1 listen before talk) for the transmission of an uplink TB (see e.g. TS 37.213, clause 4.2.1.1) and when a CAPC is not indicated in the DCI, the UE can select the CAPC as follows:
If only MAC CE(s) are included in the TB, the highest priority CAPC of those MAC CE(s) is used; or
If DCCH SDU(s) are included in the TB, the highest priority CAPC is used; or
If DCCH SDU(s) are included in the TB, the highest priority CAPC of the DCCH(s) is used; or
The lowest priority CAPC of the logical channel(s) with MAC SDU multiplexed in the TB is used otherwise.

Thus, in some wireless communications systems, there may be a mismatch between the CAPC value determined for a TB and the PDB of the TB.

Accordingly, solutions are provided in this disclosure to allow for an efficient CAPC handling for sidelink transmission on a cell configured with a shared spectrum. For instance, in at least some implementations a UE can autonomously determine the CAPC to be used when performing CAT4 listen before talk (e.g., Type 1 listen before talk) for the transmission of a sidelink TB according to some predefined rules.

In at least one example implementation, such rules may be one of the following and/or combinations thereof, where a combination may be a logical OR combination: When performing LISTEN BEFORE TALK for the transmission of a sidelink TB the UE selects the CAPC as:
If only sidelink MAC CE(s) are included in the sidelink TB, the highest priority CAPC of those sidelink MAC CE(s) is used;
If only sidelink MAC CE(s) are included in the sidelink TB, the highest priority CAPC is used;
If SBCCH SDU(s) are included in the TB, the highest priority CAPC is used;
If SCCH SDU(s) are included in the TB, the highest priority CAPC is used;
If SCCH SDU(s) are included in the TB, the highest priority CAPC of the SCCH(s) is used;
The highest priority CAPC of the sidelink logical channel(s) (e.g., STCH) with MAC SDU multiplexed in the TB is used otherwise.

Note that the SBCCH is a channel for broadcasting sidelink system information from a UE to other UE(s). SCCH is a channel for transmission of control information (i.e. PC5-RRC and PC5-S messages) from a UE to other UE(s). STCH refers to a logical channel for transmission of user data from a UE to other UE(s).

According to one or more implementations a mapping is provided between a CAPC value used for the transmission of a sidelink TB and a priority value signaled within the SCI. A table is provided, for instance, that specifies a relationship between the priority value signaled for a TB in the SCI and the CAPC value to be used when performing CAT4 listen before talk (Type 1 listen before talk) for the transmission of the sidelink TB.

According to one or more implementations a UE can select the CAPC value such that the PDB of the TB can be met. For instance the UE selects the highest priority CAPC (e.g. value=1) in scenarios where the PDB of a TB is below a configured threshold. For certain ranges of PDB values, a corresponding CAPC value to be used when performing listen before talk for a TB is defined. For instance, a UE can select the CAPC value as defined by the rules described above for scenarios where the PDB of a TB is higher than a preconfigured threshold, e.g., PDB does not affect CAPC selection since a large PDB may tolerate any CAPC priority.

According to one or more implementations, if a UE receives a DCI indicating a sidelink grant scheduling a physical sidelink shared channel (PSSCH) transmission using Type 1 channel access procedures, and if the UE has an ongoing Type 1 channel access procedures before the PSSCH transmission starting time, e.g., the UE has acquired a COT (e.g., the UE is operating in sidelink mode 2) with a CAPC value:
If the sidelink channel access priority class value p₁ used for the ongoing Type 1 channel access procedures (e.g. UE operating in sidelink mode 2) is the same or larger than the sidelink channel access priority class value p₂ indicated in the DCI, the UE may transmit the sidelink transmission (e.g. one or more of PSCCH, PSSCH, physical sidelink feedback channel (PSFCH), reference signals, etc.) in response to the sidelink grant by accessing the channel by using the ongoing Type 1 channel access procedure.
If the sidelink channel access priority class value p₁ used for the ongoing Type 1 channel access procedure is smaller than the sidelink channel access priority class value p₂ indicated in the DCI, the UE is to terminate the ongoing channel access procedure. Alternatively, UE may ignore the received DCI and continue with the COT, e.g., sidelink mode 2 transmission.

According to one or more implementations, a UE can skip a TB transmission for scenarios where the CAPC value associated with the TB cannot meet a PDB requirement of the TB. For example, a listen before talk procedure including the contention window determined as a function of the CAPC (e.g., such as described above) may not reach the condition for allowing a transmission before the PDB expires. This may be known at an initialization step of a channel access procedure if the minimum total required channel access sensing duration extends beyond the PDB of the TB, or at any time in an ongoing channel access procedure if the minimum remaining required channel access sensing duration extends beyond the PDB of the TB. In at least one implementation a UE discards the TB from the transmission buffer (e.g., HARQ transmission buffer) in scenarios where the transmission of the TB is skipped due to not meeting a PDB requirement.

According to one or more implementations a UE increases a channel access priority class priority (e.g., selects a lower channel access priority class value) for the transmission attempt of a sidelink TB in scenarios where a selected CAPC value associated with the TB cannot meet the PDB requirement of the TB. The UE, for instance, decreases the CAPC value selected for the TB by one index value and checks whether the PDB can be met. Checking whether the PDB can be met may be determined as a check assuming the minimum allowed contention window size for the CAPC value, or alternatively as a check after the initialization step of the channel access procedure, such as where a random number between 0 and CWₚ is determined.

In scenarios where a PDB can still not be met, a UE can further decrease the CAPC value. These steps can be repeated until either the PDB can be satisfied or the lowest CAPC value has been reached. In case PDB can still not be met with the lowest defined CAPC value, e.g., highest priority CAPC, a UE can skip the transmission attempt such as described above.

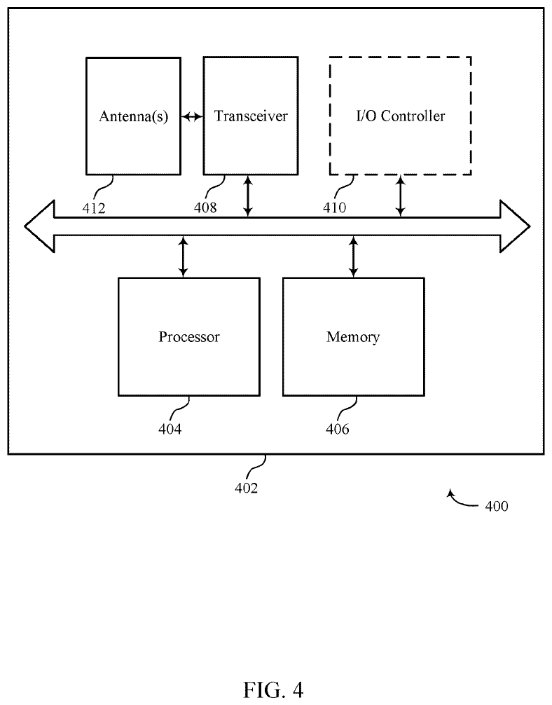

FIG. 4 illustrates an example of a block diagram 400 of a device 402 (e.g., an apparatus) that supports channel access priority for sidelink in accordance with aspects of the present disclosure. The device 402 may be an example of UE 104 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406). In the context of UE 104, for example, the transceiver 408 and the processor coupled 404 coupled to the transceiver 408 are configured to cause the UE 104 to perform the various described operations and/or combinations thereof.

For example, the processor 404 and/or the transceiver 408 may support wireless communication at the device 402 in accordance with examples as disclosed herein. For instance, the processor 404 and/or the transceiver 408 may be configured as and/or otherwise support a means to generate a transport block including one or more MAC service data units (SDU) of one or more sidelink logical channels for a sidelink transmission; perform a listen before talk procedure based at least in part on one or more channel access parameters for a CAPC priority, where the CAPC priority corresponds to a highest priority CAPC of the one or more sidelink logical channels with the one or more MAC SDU in the transport block; and transmit the transport block based at least in part on a success of the listen before talk procedure.

Further, in some implementations, the processor 404 and/or the transceiver 408 may be configured as and/or otherwise support a means to determine the CAPC priority based at least in part on a delay parameter for the one or more sidelink logical channels; where the delay parameter includes a PDB for the transport block; select a sidelink grant for use in transmitting the transport block, and where to transmit the transport block includes to transmit the transport block using the sidelink grant; perform a sensing procedure to select the sidelink grant; where the apparatus includes a user equipment (UE), and autonomously select the CAPC priority; where the apparatus includes a user equipment (UE), and determine the CAPC priority respectively value based at least in part on information received from a network entity; generate the transport block to include one or more MAC CE; and select the CAPC priority as the highest priority CAPC for the one or more MAC CE; generate the transport block to include one or more SBCCH SDU; and select the CAPC priority as the highest priority CAPC for the one or more SBCCH SDU; generate the transport block to include one or more SCCH SDU; and select the CAPC priority as the highest priority CAPC for the one or more SCCH SDU; select the CAPC priority based at least in part on priority information received as part of SCI.

In a further example, the processor 404 and/or the transceiver 408 may support wireless communication at the device 402 in accordance with examples as disclosed herein. The processor 404 and/or the transceiver 408, for instance, may be configured as or otherwise support a means to perform a channel access procedure to acquire a COT associated with a first CAPC priority for a listen before talk procedure; receive DCI specifying a sidelink grant and a second CAPC priority for the sidelink grant for a listen before talk procedure; and determine whether to utilize the COT to transmit a sidelink transmission based on a comparison of the first CAPC priority and the second CAPC priority.

Further, in some implementations, the processor and the transceiver are configured to cause the apparatus to determine that the first CAPC priority is equal to or higher than the second CAPC priority; and transmit the sidelink transmission utilizing the COT based at least in part on the first CAPC priority being equal to or higher than the second CAPC priority; determine that the first CAPC priority is lower than the second CAPC priority; terminate the COT; and initiate transmission of the sidelink transmission utilizing the sidelink grant and based at least in part on the second CAPC priority.

In a further example, the processor 404 and/or the transceiver 408 may support wireless communication at the device 402 in accordance with examples as disclosed herein. The processor 404 and/or the transceiver 408, for instance, may be configured as or otherwise support a means to generate a transport block including one or more MAC SDU of one or more sidelink logical channels for a sidelink transmission; and process the transport block based on a comparison of a CAPC priority of the transport block for a listen before talk procedure to a PDB of the transport block.

Further, in some implementations, the processor and the transceiver are configured to cause the apparatus to determine that a contention window used for the listen before talk procedure is greater than the PDB of the transport block, where the contention window is determined based on the CAPC priority; and determine not to transmit the transport block based at least in part on the contention window for the listen before talk procedure being greater than the PDB of the transport block; determine the contention window based on the CAPC priority for the listen before talk procedure is greater than the PDB of the transport block at one or more of: initialization of a channel access procedure for accessing the one or more sidelink logical channels; or after initialization of the channel access procedure; discard the transport block from a transmission buffer.

Further, in some implementations, to process the transport block, determine that a contention window for the listen before talk procedure is greater than the PDB of the transport block, where the contention window is determined based on the CAPC priority/value; adjust the CAPC priority; determine that a contention window determined based on the adjusted CAPC priority is less than the PDB of the transport block; and transmit the transport block based at least in part on the adjusted CAPC priority; where to process the transport block, determine that a contention window for the listen before talk procedure is greater than the PDB of the transport block, where the contention window is determined based on the CAPC priority; adjust the CAPC priority; determine that a contention window determined based on the adjusted CAPC priority is greater than the PDB of the transport block; and determine not to transmit the transport block based at least in part on the adjusted CAPC priority.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor M08. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (e.g., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

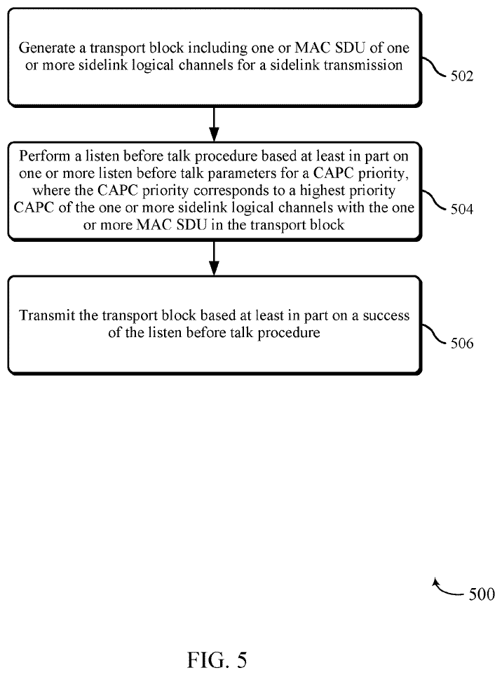

FIG. 5 illustrates a flowchart of a method 500 that supports channel access priority for sidelink in accordance with aspects of the present disclosure. The operations of the method 500 may be implemented by a device or its components as described herein. For example, the operations of the method 500 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 502, the method may include generating a transport block including one or MAC SDU of one or more sidelink logical channels for a sidelink transmission. The operations of 502 may be performed in accordance with examples as described herein. In some implementations, aspects of the operations of 502 may be performed by a device as described with reference to FIG. 1.

At 504, the method may include performing a listen before talk procedure based at least in part on one or more listen before talk parameters for a CAPC priority, where the CAPC priority corresponds to a highest priority CAPC of the one or more sidelink logical channels with the one or more MAC SDU in the transport block. The operations of 504 may be performed in accordance with examples as described herein. In some implementations, aspects of the operations of 504 may be performed by a device as described with reference to FIG. 1.

At 506, the method may include transmitting the transport block based at least in part on a success of the listen before talk procedure. The operations of 506 may be performed in accordance with examples as described herein. In some implementations, aspects of the operations of 506 may be performed by a device as described with reference to FIG. 1.

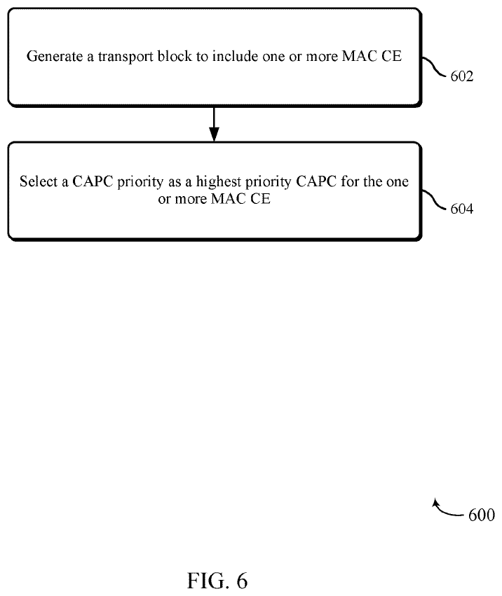

FIG. 6 illustrates a flowchart of a method 600 that supports channel access priority for sidelink in accordance with aspects of the present disclosure. The operations of the method 600 may be implemented by a device or its components as described herein. For example, the operations of the method 600 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 602, the method may include generating a transport block to include one or more MAC CE. The operations of 602 may be performed in accordance with examples as described herein. In some implementations, aspects of the operations of 602 may be performed by a device as described with reference to FIG. 1.

At 604, the method may include selecting a CAPC priority as a highest priority CAPC for the one or more MAC CE. The operations of 604 may be performed in accordance with examples as described herein. In some implementations, aspects of the operations of 604 may be performed by a device as described with reference to FIG. 1.

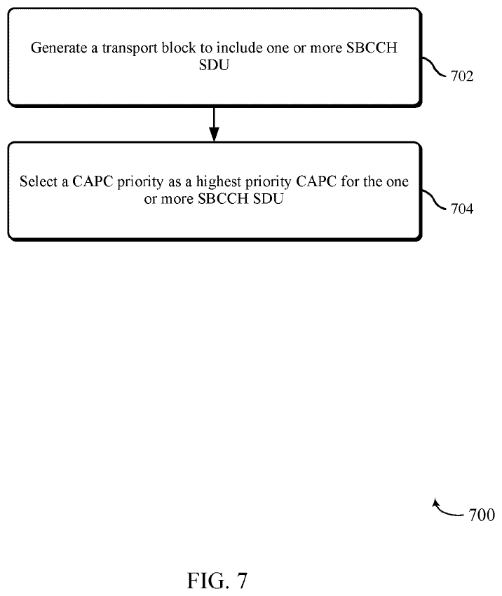

FIG. 7 illustrates a flowchart of a method 700 that supports channel access priority for sidelink in accordance with aspects of the present disclosure. The operations of the method 700 may be implemented by a device or its components as described herein. For example, the operations of the method 700 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 702, the method may include generating a transport block to include one or more SBCCH SDU. The operations of 702 may be performed in accordance with examples as described herein. In some implementations, aspects of the operations of 702 may be performed by a device as described with reference to FIG. 1.

At 704, the method may include selecting a CAPC priority as a highest priority CAPC for the one or more SBCCH SDU. The operations of 704 may be performed in accordance with examples as described herein. In some implementations, aspects of the operations of 704 may be performed by a device as described with reference to FIG. 1.

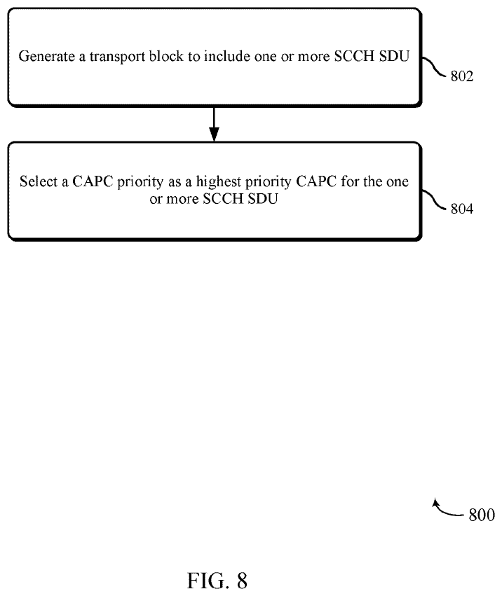

FIG. 8 illustrates a flowchart of a method 800 that supports channel access priority for sidelink in accordance with aspects of the present disclosure. The operations of the method 800 may be implemented by a device or its components as described herein. For example, the operations of the method 800 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 802, the method may include generating a transport block to include one or more SCCH SDU. The operations of 802 may be performed in accordance with examples as described herein. In some implementations, aspects of the operations of 802 may be performed by a device as described with reference to FIG. 1.

At 804, the method may include selecting a CAPC priority as a highest priority CAPC for the one or more SCCH SDU. The operations of 804 may be performed in accordance with examples as described herein. In some implementations, aspects of the operations of 804 may be performed by a device as described with reference to FIG. 1.

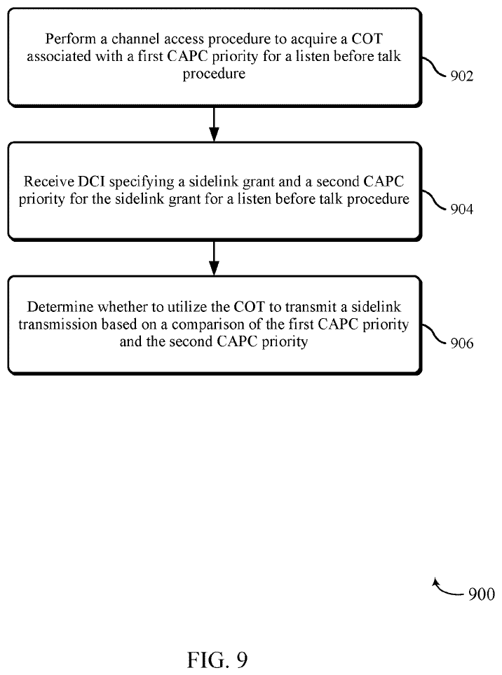

FIG. 9 illustrates a flowchart of a method 900 that supports channel access priority for sidelink in accordance with aspects of the present disclosure. The operations of the method 900 may be implemented by a device or its components as described herein. For example, the operations of the method 900 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 902, the method may include performing a channel access procedure to acquire a COT associated with a first CAPC priority for a listen before talk procedure. The operations of 902 may be performed in accordance with examples as described herein. In some implementations, aspects of the operations of 902 may be performed by a device as described with reference to FIG. 1.

At 904, the method may include receiving DCI specifying a sidelink grant and a second CAPC priority for the sidelink grant for a listen before talk procedure. The operations of 904 may be performed in accordance with examples as described herein. In some implementations, aspects of the operations of 904 may be performed by a device as described with reference to FIG. 1.

At 906, the method may include determining whether to utilize the COT to transmit a sidelink transmission based on a comparison of the first CAPC priority and the second CAPC priority. The operations of 906 may be performed in accordance with examples as described herein. In some implementations, aspects of the operations of 906 may be performed by a device as described with reference to FIG. 1.

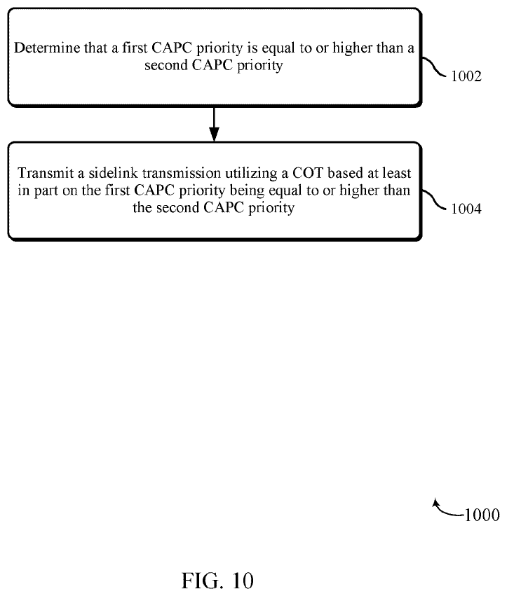

FIG. 10 illustrates a flowchart of a method 1000 that supports channel access priority for sidelink in accordance with aspects of the present disclosure. The operations of the method 1000 may be implemented by a device or its components as described herein. For example, the operations of the method 1000 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1002, the method may include determining that a first CAPC priority is equal to or higher than a second CAPC priority. The operations of 1002 may be performed in accordance with examples as described herein. In some implementations, aspects of the operations of 1002 may be performed by a device as described with reference to FIG. 1.

At 1004, the method may include transmitting a sidelink transmission utilizing a COT based at least in part on the first CAPC priority being equal to or higher than the second CAPC priority. The operations of 1004 may be performed in accordance with examples as described herein. In some implementations, aspects of the operations of 1004 may be performed by a device as described with reference to FIG. 1.

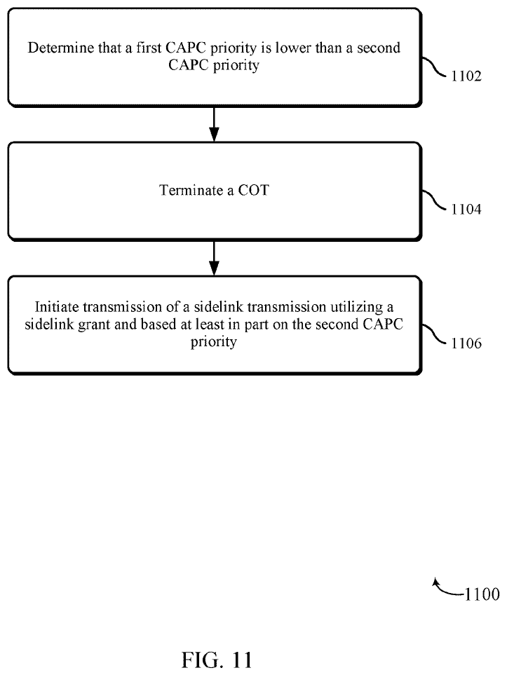

FIG. 11 illustrates a flowchart of a method 1100 that supports channel access priority for sidelink in accordance with aspects of the present disclosure. The operations of the method 1100 may be implemented by a device or its components as described herein. For example, the operations of the method 1100 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1102, the method may include determining that a first CAPC priority is lower than a second CAPC priority. The operations of 1102 may be performed in accordance with examples as described herein. In some implementations, aspects of the operations of 1102 may be performed by a device as described with reference to FIG. 1.

At 1104, the method may include terminating a COT. The operations of 1104 may be performed in accordance with examples as described herein. In some implementations, aspects of the operations of 1104 may be performed by a device as described with reference to FIG. 1.

At 1106, the method may include initiating transmission of a sidelink transmission utilizing a sidelink grant and based at least in part on the second CAPC priority. The operations of 1106 may be performed in accordance with examples as described herein. In some implementations, aspects of the operations of 1106 may be performed by a device as described with reference to FIG. 1.

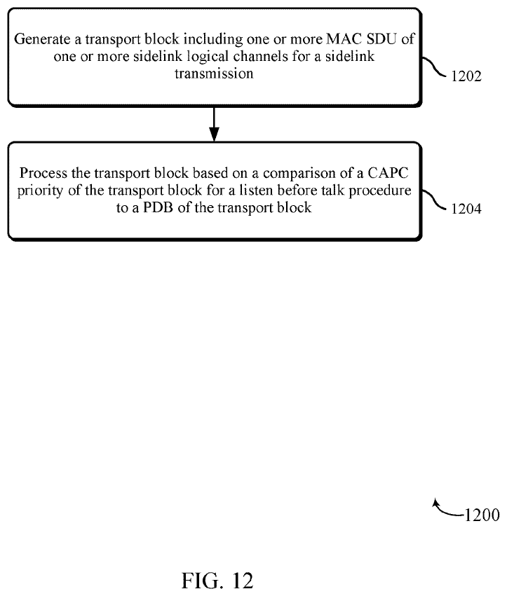

FIG. 12 illustrates a flowchart of a method 1200 that supports channel access priority for sidelink in accordance with aspects of the present disclosure. The operations of the method 1200 may be implemented by a device or its components as described herein. For example, the operations of the method 1200 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1202, the method may include generating a transport block including one or more MAC SDU of one or more sidelink logical channels for a sidelink transmission. The operations of 1202 may be performed in accordance with examples as described herein. In some implementations, aspects of the operations of 1202 may be performed by a device as described with reference to FIG. 1.

At 1204, the method may include processing the transport block based on a comparison of a CAPC priority of the transport block for a listen before talk procedure to a PDB of the transport block. The operations of 1204 may be performed in accordance with examples as described herein. In some implementations, aspects of the operations of 1204 may be performed by a device as described with reference to FIG. 1.

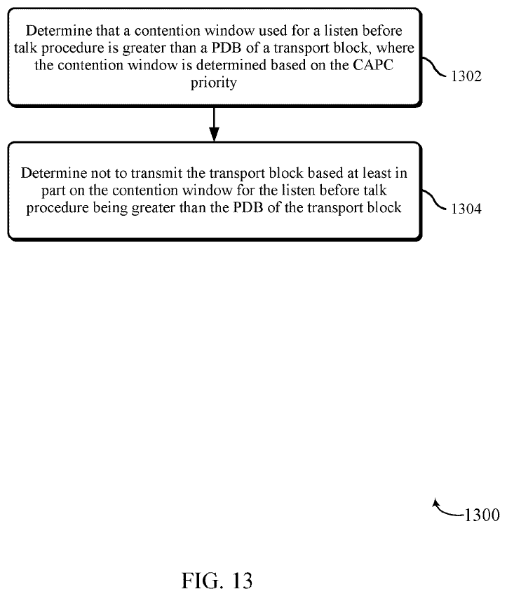

FIG. 13 illustrates a flowchart of a method 1300 that supports channel access priority for sidelink in accordance with aspects of the present disclosure. The operations of the method 1300 may be implemented by a device or its components as described herein. For example, the operations of the method 1300 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1302, the method may include determining that a contention window used for a listen before talk procedure is greater than a PDB of a transport block, where the contention window is determined based on the CAPC priority. The operations of 1302 may be performed in accordance with examples as described herein. In some implementations, aspects of the operations of 1302 may be performed by a device as described with reference to FIG. 1.

At 1304, the method may include determining not to transmit the transport block based at least in part on the contention window for the listen before talk procedure being greater than the PDB of the transport block. The operations of 1304 may be performed in accordance with examples as described herein. In some implementations, aspects of the operations of 1304 may be performed by a device as described with reference to FIG. 1.

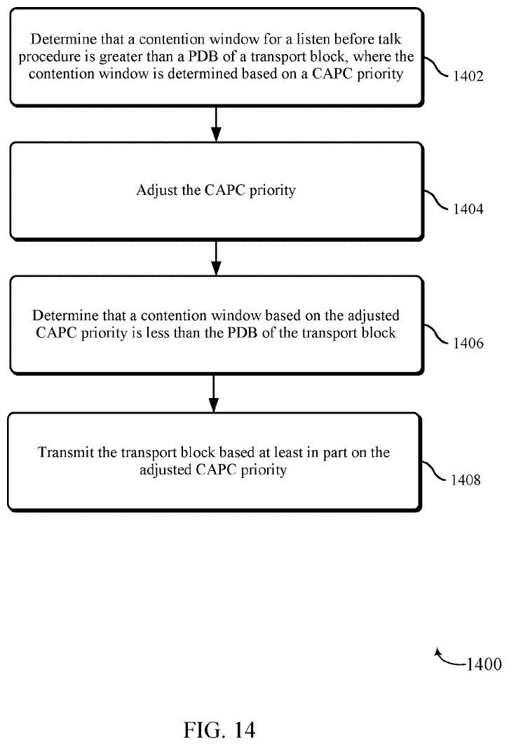

FIG. 14 illustrates a flowchart of a method 1400 that supports channel access priority for sidelink in accordance with aspects of the present disclosure. The operations of the method 1400 may be implemented by a device or its components as described herein. For example, the operations of the method 1400 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1402, the method may include determining that a contention window for a listen before talk procedure is greater than a PDB of a transport block, where the contention window is determined based on a CAPC priority. The operations of 1402 may be performed in accordance with examples as described herein. In some implementations, aspects of the operations of 1402 may be performed by a device as described with reference to FIG. 1.

At 1404, the method may include adjusting the CAPC priority. The operations of 1404 may be performed in accordance with examples as described herein. In some implementations, aspects of the operations of 1404 may be performed by a device as described with reference to FIG. 1.

At 1406, the method may include determining that a contention window based on the adjusted CAPC priority is less than the PDB of the transport block. The operations of 1406 may be performed in accordance with examples as described herein. In some implementations, aspects of the operations of 1406 may be performed by a device as described with reference to FIG. 1.

At 1408, the method may include transmitting the transport block based at least in part on the adjusted CAPC priority. The operations of 1408 may be performed in accordance with examples as described herein. In some implementations, aspects of the operations of 1408 may be performed by a device as described with reference to FIG. 1.

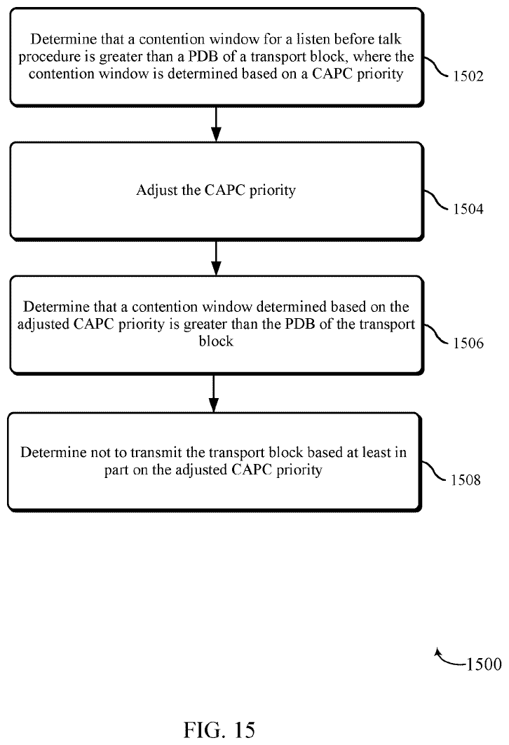

FIG. 15 illustrates a flowchart of a method 1500 that supports channel access priority for sidelink in accordance with aspects of the present disclosure. The operations of the method 1500 may be implemented by a device or its components as described herein. For example, the operations of the method 1500 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1502, the method may include determining that a contention window for a listen before talk procedure is greater than a PDB of a transport block, where the contention window is determined based on a CAPC priority. The operations of 1502 may be performed in accordance with examples as described herein. In some implementations, aspects of the operations of 1502 may be performed by a device as described with reference to FIG. 1.

At 1504, the method may include adjusting the CAPC priority. The operations of 1504 may be performed in accordance with examples as described herein. In some implementations, aspects of the operations of 1504 may be performed by a device as described with reference to FIG. 1.

At 1506, the method may include determining that a contention window determined based on the adjusted CAPC priority is greater than the PDB of the transport block. The operations of 1506 may be performed in accordance with examples as described herein. In some implementations, aspects of the operations of 1506 may be performed by a device as described with reference to FIG. 1.

At 1508, the method may include determining not to transmit the transport block based at least in part on the adjusted CAPC priority. The operations of 1508 may be performed in accordance with examples as described herein. In some implementations, aspects of the operations of 1508 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1-20. (canceled)

21. A user equipment (UE) for wireless communication, comprising:
at least one memory; and
at least one processor coupled with the at least one memory and configured to cause the UE to:
generate a sidelink transport block including one or more sidelink medium access control (MAC) control elements (CE); and
perform a listen before talk (LBT) procedure based at least in part on a sidelink channel access priority class (CAPC) priority for the sidelink transport block, wherein the sidelink CAPC priority for the sidelink transport block corresponds to a highest priority sidelink CAPC.

22. The UE of claim 21, wherein the at least one processor is configured to cause the UE to:
transmit the sidelink transport block based at least in part on a success of the LBT procedure.

23. The UE of claim 21, wherein the generated sidelink transport block only includes the one or more sidelink MAC-CEs.

24. The UE of claim 21, wherein the at least one processor is configured to cause the UE to:
select a sidelink grant for transmission of the sidelink transport block; and
transmit, based at least in part on a success of the LBT procedure, the sidelink transport block using the sidelink grant.

25. The UE of claim 21, wherein the sidelink CAPC priority is selected autonomously by the UE.

26. The UE of claim 21, wherein the sidelink CAPC priority is selected based at least in part on information received from a network entity.

27. A user equipment (UE) for wireless communication, comprising:
at least one memory; and
at least one processor coupled with the at least one memory and configured to cause the UE to:
generate a sidelink transport block including one or more sidelink broadcast control channel (SBCCH) service data units (SDU); and
perform a listen before talk (LBT) procedure based at least in part on a sidelink channel access priority class (CAPC) priority for the sidelink transport block, wherein the sidelink CAPC priority for the sidelink transport block corresponds to a highest priority sidelink CAPC.

28. The UE of claim 27 wherein the at least one processor is configured to cause the UE to:
transmit the sidelink transport block based at least in part on a success of the LBT procedure.

29. The UE of claim 27, wherein the at least one processor is configured to cause the UE to:
select a sidelink grant for transmission of the sidelink transport block; and
transmit, based at least in part on a success of the LBT procedure, the sidelink transport block using the sidelink grant.

30. The UE of claim 27, wherein the sidelink CAPC priority is selected autonomously by the UE.

31. The UE of claim 27, wherein the sidelink CAPC priority is selected based at least in part on information received from a network entity.

32. A user equipment (UE) for wireless communication, comprising:
at least one memory; and
at least one processor coupled with the at least one memory and configured to cause the UE to:
generate a sidelink transport block including one or more sidelink control channel (SCCH) service data units (SDU); and
perform a listen before talk (LBT) procedure based at least in part on a sidelink channel access priority class (CAPC) priority of the sidelink transport block, wherein the sidelink CAPC priority of the sidelink transport block corresponds to a highest priority sidelink CAPC.

33. The UE of claim 32 wherein the at least one processor is configured to cause the UE to:
transmit the sidelink transport block based at least in part on a success of the LBT procedure.

34. The UE of claim 32, wherein the at least one processor is configured to cause the UE to:
select a sidelink grant for transmission of the sidelink transport block; and
transmit, based at least in part on a success of the LBT procedure, the sidelink transport block using the sidelink grant.

35. The UE of claim 32, wherein the sidelink CAPC priority is selected autonomously by the UE.

36. The UE of claim 32, wherein the sidelink CAPC priority is selected based at least in part on information received from a network entity.

37. A processor for wireless communication, comprising:
at least one controller coupled with at least one memory and configured to cause the processor to:
generate a sidelink transport block including one of:
one or more medium access control (MAC) control elements (CE);
one or more sidelink broadcast control channel (SBCCH) service data units (SDU); or
one or more sidelink control channel (SCCH) SDUs; and
perform a listen before talk (LBT) procedure based at least in part on a sidelink channel access priority class (CAPC) priority of the sidelink transport block, wherein the sidelink CAPC priority corresponds to a highest priority sidelink CAPC.

38. The processor of claim 37, wherein the at least one controller is configured to cause the processor to:
transmit the sidelink transport block based at least in part on a success of the LBT procedure.
transmit, based at least in part on a success of the LBT procedure, the sidelink transport block using the sidelink grant.

39. The processor of claim 37, wherein the generated sidelink transport block only includes the one or more MAC-CEs.

40. The processor of claim 37, wherein the sidelink CAPC priority is selected autonomously by the processor, or selected based at least in part on information received from a network entity.
